(19) United States
(12) Patent Application Publication
(10) Pub. No.: US 2013/0090360 A1
(43) Pub. Date: Apr. 11, 2013

(54) Method for protecting rice from being infected by fungi

(71) Applicant: Reinhard Stierl, Pune (IN)

(72) Inventor: Reinhard Stierl, Pune (IN)

(73) Assignee: BASF SE, Ludwigshafen (DE)

(21) Appl. No.: 13/703,822

(22) PCT Filed: Jun. 17, 2011
(86) PCT No.: PCT/IB2011/052653

§ 371 Date: Dec. 18, 2012

(30) Foreign Application Priority Data
Jun. 18, 2010 (EP) 10166514.9

(51) Int. Cl. A01N 43/653; A01N 61/00; A01N 43/90

(52) U.S. Cl. CPC A01N 43/653; A01N 43/90; A01N 61/00
USPC 514/366

(57) ABSTRACT

Method for protecting rice from being infected by harmful fungi, wherein the fungi, their habitat, rice plants, their seed, rice plant propagation material or the soil on which rice is grown or intended to be grown, is treated with epoxiconazole and tricyclazole in synergistically effective amounts; use of a composition comprising epoxiconazole, tricyclazole and optionally a further commercially available fungicide, for preparing a composition suitable for protecting rice from being infected by harmful fungi.

The invention relates to a method for protecting rice plants from being infected by specific harmful fungi, wherein the rice plants, their seed or the soil is treated with a fungicidal effective amount of a synergistically active combination comprising epoxiconazole and tricyclazole.

Over recent years, there has been an increase of fungal infections in rice, resulting in considerable harvest and yield losses.

WO 97/40683 already teaches that the composition of propiconazole and tricyclazole is suitable for treating rice against Pyricularia and Rhizoctonia. However, the performance of said combination against fungal rice pathogens is still not completely satisfactory in all respects. Accordingly, a need exists for agents which control fungal pathogens on rice plants more efficiently.

It has now been found that a combination comprising epoxiconazole and tricyclazole has excellent activity against harmful fungi in rice.

Epoxiconazole and tricyclazole can be present in different isomeric forms. Their preparation and their action against harmful fungi are generally known to a person skilled in the art. Both compounds are commercially available (cf., for example, www.alanwood.net/pesticides/index_cn_frame.html).

The combination comprising epoxiconazole and tricyclazole is particularly suitable for controlling the following harmful fungi in rice:
Pyricularia grisea (syn. Pyricularia oryzae; rice blast).
Rhizoctonia solani (syn in rice Pellicularia sasakii, sheath blight),
Bipolaris oryzae (brown spot),
Microdochium oryzae (leaf scald),
Ustilaginoidea virens (false smut),
Curvularia lunata,
Cercospora orzyae,
Helminthosporium oryzae and/or
Fusarium spp.

In one aspect of the invention, the control of Pyricularia grisea and/or Rhizoctonia solani is particularly preferred.

In another aspect of the invention, the control of Bipolaris oryzae, Microdochium oryzae and/or Ustilaginoidea virens is preferred.

In still another aspect of the invention, the control of dirty panicle complex—a combination of various diseases in combination Curvularia lunata, Cercospora orzyae, Helminthosporium oryzae and/or Fusarium spp. is preferred.

The control of Pyricularia grisea and/or Rhizoctonia solani is very particularly preferred.

The rice plants or seed treated with the combinations of epoxiconazole and tricyclazole may by wildlife types, plants or seed obtained by breeding, mutagenesis or genetic engineering including but not limiting to agricultural biotech products on the market or in development, as well as rice plants which have been rendered tolerant to applications of specific classes of herbicides.

Genetically modified plants are plants, which genetic material has been so modified by the use of recombinant DNA techniques that under natural circumstances cannot readily be obtained by cross breeding, mutations or natural recombination (e.g. Golden Rice). Typically, one or more genes have been integrated into the genetic material of a genetically modified plant in order to improve certain properties of the plant. Such genetic modifications also include but are not limited to targeted post-translational modification of protein(s), oligo- or polypeptides e. g. by glycosylation or polymer additions such as prenylated, acetylated or farnesylated moieties or PEG moieties.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

Epoxiconazole and tricyclazole can be applied simultaneously, that is jointly or separately, or in succession, the sequence, in the case of separate application, generally not having any effect on the result of the control measures.

The harmful fungi are controlled by applying the combination comprising epoxiconazole and tricyclazole by treating the seed, by spraying or dusting the plants or the soil before or after sowing of the plants, or before or after emergence of the plants.

The fungal diseases in rice are controlled advantageously by applying an aqueous preparation of a formulation comprising epoxiconazole and tricyclazole, or formulations comprising the single components, to the above-ground parts of the plants, in particular the leaves, or, as a prophylactic on account of the high systemic effectiveness, by treating the seed or the soil.

10

Epoxiconazole and tricyclazole are usually applied in a weight ratio of from 100:1 to 1:100, preferably from 20:1 to 1:20, in particular from 10:1 to 1:10.

Though generally combinations of epoxiconazole and tricyclazole are employed, furthey compounds active against harmful fungi or other pests, such as insects, arachnids or nematodes, or else herbicidal or growth-regulating active compounds or fertilizers may be added.

Accordingly, the invention also relates to methods for controlling harmful fungi in rice, wherein the rice plants, their seed or the soil is treated with a fungicidal effective amount of a synergistically active combination comprising epoxiconazole, tricyclazole and at least one futher active compound as indicated above, which is preferably a commercially availably fungicide, in particular kresoxim-methyl.

The futher active compound is usually employed in a weight ratio of from 100:1 to 1:100, preferably from 20:1 to 1:20, in particular from 10:1 to 1:10, based on the amount of epoxiconazole or tricyclazole.

Most preferrably, the further active compound is applied together with epoxiconazole and tricyclazole in synergistically effective amounts.

Combinations of epoxiconazole and tricyclazole with a herbicide are used in particular in rice varieties in which the sensitivity of the plants to the herbicide, i.e. glyphosate, is reduced.

When applying a combination comprising epoxiconazole and tricyclazole in rice, the yields are increased considerably. Thus, the combination comprising epoxiconazole and tricyclazole may also be used to increase the yield. By virtue of the yield increase in combination with the excellent action against harmful fungi in rice, the method according to the invention is of particular benefit to the farmer.

The combination comprising epoxiconazole, tricyclazole and optionally a further active compound is applied by treating the fungi or the plants, plant propagation material or seeds to be protected against fungal attack or the soil with effective amounts of the active compounds. Application can be both before and after the infection of the plant propagation material or plants with the fungi.

The application rates for epoxyconazole, tricyclazole and, if desired, the further active compound are generally from 1 to 1500 g/ha, preferably from 10 to 1250 g/ha, in particular from 20 to 1000 g/ha.

The application rates of the combinations according to the invention are preferably from 10 g/ha to 2500 g/ha, more preferably from 50 to 2000 g/ha, in particular from 100 to 1500 g/ha.

Very particularly preferred are epoxiconazole amounts from 20 to 200 g/ha and tricyclazole amounts from 60 to 600 g/ha.

In the treatment of seed, the amounts of active compound required are generally from 1 to 1500 g, preferably from 10 to 500 g, per 100 kilograms of seed.

In the treatment of seed, application rates of combinations according to this invention are generally from 1 to 2000 g/100 kg of seed, preferably from 1 to 1500 g/100 kg, in particular from 5 to 1000 g/100 kg.

For use in the method according to the invention, the compounds can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner [cf., for example, U.S. Pat. No. 3,060,084, EP-A 707 445 (liquid concentrates), Browning, “Agglomeration”, Chemical Engineering, Dec. 4, 1967, 147-48, Perry's Chemical Engineer's Handbook, 4th edition, McGraw-Hill, New York, 1963, pages 8-57, WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th edition, Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8)], for example by extending the active compound with solvents and/or carriers, if desired using emulsifiers, surfactants, dispersants, stabilizers, antifoams and antifreeze agents. For formulations for treating seed, color pigments (for example rhodamine B), binders and/or swelling agents may additionally be considered.

Solvents/auxiliaries suitable for this purpose are essentially:
water, aromatic solvents (for example Solvesso® products, xylene), paraffins (for example mineral oil fractions), alcohols (for example methanol, butanol, pentanol, benzyl alcohol), ketones (for example cyclohexanone, gamma-butyrolactone), pyrrolidones (N-methylpyrrolidone, N-octylpyrrolidone), acetates (glycol diacetate), glycols, fatty acid dimethylamides, fatty acids and fatty acid esters. In principle, solvent mixtures may also be used.
carriers such as ground natural minerals (for example kaolins, clays, talc, chalk) and ground synthetic minerals (for example finely divided silicic acid, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable for use as surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Suitable antifreeze agents are, for example, glycerol, ethylene glycol and propylene glycol.

Suitable antifoams are, for example, silicon stearates or magnesium stearates.

A suitable swelling agent is, for example, carrageen (Satiagel®).

Binders serve to improve the adhesion of the active compound or the active compounds on the seed. Suitable binders are, for example, polyethylene oxide/polypropylene oxide copolymers, polyvinyl alcohol, polyvinylpyrrolidone, poly(meth)acraylate, polybutene, polyisobutylene, polystyrene, polyethyleneamine, polyethyleneamide, polyethyleneimine (Lupasol®, Polymin®), polyethers, polyurethanes, polyvinyl acetate and the copolymers of the above polymers.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound(s). The active compounds are employed in a purity of from 90% to 100%, preferably 95% to 100% (according to NMR spectrum).

For seed treatment, the formulations can be diluted 2 to 10 times, resulting in ready-to-use preparations comprising from 0.01 to 60% by weight of the active compounds, preferably from 0.1 to 40% by weight of the active compounds.

The following are examples of formulations: 1. Products for dilution with water

A) Water-Soluble Concentrates (SL, LS)

10 parts by weight of the active compound(s) are dissolved with 90 parts by weight of water or a water-soluble solvent. As an alternative, wetting agents or other auxiliaries are added. The active compound dissolves upon dilution with water. This gives a formulation having an active compound content of 10% by weight.

B) Dispersible Concentrates (DC)

20 parts by weight of the active compound(s) are dissolved in 70 parts by weight of cyclohexanone with addition of 10 parts by weight of a dispersant, for example polyvinylpyrrolidone. Dilution with water gives a dispersion. The active compound content is 20% by weight.

C) Emulsifiable Concentrates (EC)

15 parts by weight of the active compound(s) are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

D) Emulsions (EW, EO, ES)

25 parts by weight of the active compound(s) are dissolved in 35 parts by weight of xylene with addition of calcium dodecylbenzenesulfonate and castor oil ethoxylate (in each case 5 parts by weight). This mixture is added to 30 parts by weight of water by means of an emulsifying machine (e.g. Ultraturrax) and made into a homogeneous emulsion. Dilution with water gives an emulsion. The formulation has an active compound content of 25% by weight.

E) Suspensions (SC, OD, FS)

In an agitated ball mill, 20 parts by weight of the active compound(s) are comminuted with addition of 10 parts by weight of dispersants and wetting agents and 70 parts by weight of water or an organic solvent to give a fine active compound suspension. Dilution with water gives a stable suspension of the active compound. The active compound content in the formulation is 20% by weight.

F) Water-Dispersible Granules and Water-Soluble Granules (WG, SG)

50 parts by weight of the active compound(s) are ground finely with addition of 50 parts by weight of dispersants and wetting agents and made into water-dispersible or water-soluble granules by means of technical appliances (for example extrusion, spray tower, fluidized bed). Dilution with water gives a stable dispersion or solution of the active compound. The formulation has an active compound content of 50% by weight.

G) Water-Dispersible Powders and Water-Soluble Powders (WP, SP, SS, WS)

75 parts by weight of the active compound(s) are ground in a rotor-stator mill with addition of 25 parts by weight of dispersants, wetting agents and silica gel. Dilution with water gives a stable dispersion or solution of the active compound. The active compound content of the formulation is 75% by weight.

H) Gels (GF)

20 parts by weight of the active compound(s) are, with addition of 10 parts by weight of dispersants, 1 part by weight of gelling agent and 70 parts by weight of water or an organic solvent, comminuted in a bead mill to give a fine active compound suspension. Dilution with water affords a stabile suspension of the active compound. The formulation has an active compound content of 20 parts by weight.

2. Products to be Applied Undiluted

J) Dustable Powders (DP, DS)

5 parts by weight of the active compound(s) are ground finely and mixed intimately with 95 parts by weight of finely divided kaolin. This gives a dustable product with an active compound content of 5% by weight.

K) Granules (GR, FG, GG, MG)

0.5 part by weight of the active compound(s) are ground finely and associated with 99.5 parts by weight of carriers. Current methods are extrusion, spray-drying or the fluidized bed. This gives granules with an active compound content of 0.5% by weight to be applied undiluted.

L) ULV Solutions (UL)

10 parts by weight of the active compound(s) are dissolved in 90 parts by weight of an organic solvent, for example xylene. This gives a product with an active compound content of 10% by weight to be applied undiluted.

Suitable for seed treatment are in particular FS formulations. Typically, such an FS formulation comprises 1 to 800 g of active compound(s) per liter, 1 to 200 g of surfactant/l, 0 to 200 g of antifreeze/l, 0 to 400 g of binder/l, 0 to 200 g of color pigment/l and ad 1 liter of a solvent, preferably water.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetting agent, tackifier, dispersant or emulsifier. However, it is also possible to prepare concentrates composed of active substance, wetting agent, tackifier, dispersant or emulsifier and, if appropriate, solvent or oil, with these concentrates being suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetting agents, adjuvants, herbicides, fungicides, other pesticides, or bactericides may be added to the active compounds even, if appropriate, not until immediately prior to use (tank mix). These agents are typically admixed with the compositions according to the invention in a weight ratio of from 1:100 to 100:1, preferably from 1:10 to 10:1.

### USE EXAMPLES

Epoxiconazole and tricyclazole were employed as commercial finished formulations (EC and SC) and diluted with water to the stated concentration of active compound.

### Example 1

### Activity Against Pyricuaria oryzae (Rice Blast)

The trial was conducted under field conditions. Rice plants (variety Tainong 67) were planted and grown under standard conditions with adequate supply of water and nutrients. After 34 days a first application of active compounds was made, which was repeated after 9 and after 19 days. No other compounds were applied for pathogen control. Infection with pathogens occurred naturally. The disease incidences were evaluated 15 days after the first application (Pyricularia oryzae.).

The diseases were converted into efficacies. An efficacy of 0 means that the infection level of the treated plants corresponds to that of the untreated control plants; an efficacy of 100 means that the treated plants were not infected.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

E=x+y−x·y/100 Colby's formula:

E expected efficacy, expressed in % of the untreated control, when using the mixture of the active compounds A and B at the concentrations a and b

x efficacy, expressed in % of the untreated control, when using the active compound A at the concentration a

y efficacy, expressed in % of the untreated control, when using the active compound B at the concentration b

The dosages used and the obtained results are shown below:

| | Applica- | Efficacy % | | |
|---|---|---|---|---|
| | tion | 15 days | Calculated | |
| | rate | after first | efficacy | Synergism |
| Product | [g ai/ha] | application | (Colby) | % |
| untreated | — | 37.3 (% disease) | | — |
| Tricyclazol | 100 | 34.9 | — | — |
| Epoxiconazole (EPX) | 25 | 17.7 | — | — |
| Epoxiconazole (EPX) | 50 | 24.1 | — | — |
| Epoxiconazole (EPX) | 75 | 35.1 | — | — |
| EPX + Tricyclazol | 50 + 100 | 70.2 | 50.6 | 19.7 |
| EPX + Tricyclazol | 75 + 100 | 71.0 | 57.7 | 13.3 |

The test results show that, by virtue of the strong synergism, the mixtures according to the invention are considerably more active than had been predicted using Colby's formula.

### Example 2

### Activity against Pyricuaria oryzae (Rice Blast)

The trial was conducted under field conditions. Rice plants (variety Tainong 67) were planted and grown under standard conditions with adequate supply of water and nutrients. After 42 days a first application of active compounds was made, which was repeated after 13 and after 26 days. No other compounds were applied for pathogen controt. Infection with pathogens occurred naturally. The disease incidences were evaluated 22 days after the first application (Pyricuaria oryzae.).

The diseases were converted into efficacies. An efficacy of 0 means that the infection level of the treated plants corresponds to that of the untreated control plants; an efficacy of 100 means that the treated plants were not infected.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

The dosages used and the obtained results are shown below:

| | Applica- | Efficacy % | | |
|---|---|---|---|---|
| | tion | 22 days | Calculated | |
| | rate | after first | efficacy | Synergism |
| Product | [g ai/ha] | application | (Colby) | % |
| untreated | — | 16.1 (% disease) | | — |
| Tricyclazol | 100 | 5.6 | — | — |
| Tricyclazol | 200 | 0.0 | — | — |
| Epoxiconazole (EPX) | 25 | 1.2 | — | — |
| Epoxiconazole (EPX) | 50 | 0.0 | — | — |
| Epoxiconazole (EPX) | 75 | 5.6 | — | — |
| EPX + Tricyclazol | 50 + 100 | 44.7 | 5.6 | 39.1 |
| EPX + Tricyclazol | 75 + 100 | 59.6 | 10.9 | 48.8 |
| EPX + Tricyclazol | 25 + 200 | 34.2 | 1.2 | 32.9 |
| EPX + Tricyclazol | 50 + 200 | 36.6 | 0.0 | 36.6 |
| EPX + Tricyclazol | 75 + 200 | 67.1 | 5.6 | 61.5 |

The test results show that, by virtue of the strong synergism, the mixtures according to the invention are considerably more active than had been predicted using Colby's formula.

1-7. (canceled)

8. A method for protecting rice from being infected by phytopathogenic harmful fungi, wherein the fungi, their habitat, rice plants, their seed, rice plant propagation material or the soil on which rice is grown or intended to be grown, is treated with epoxiconazole and tricyclazole in synergistically effective amounts.

9. The method according to claim 8, wherein the phytopathogenic harmful fungi to be controlled are selected from the group Pyricularia grisea (syn. Pyricularia oryzae). Rhizoctonia solani (syn in rice Pellicularia sasakii), Bipolaris oryzae, Microdochium oryzae, Ustilaginoidea virens, Curvularia lunata, Cercospora orzyae, Helminthosporium oryzae and Fusarium spp.

10. The method according to claim 8, wherein an aqueous preparation of a formulation comprising epoxiconazole and tricyclazole is applied to the above-ground parts of the rice plants.

11. A method according to claim 8, whereas plant propagation material is treated.

12. The method according to claim 8, wherein a combination of epoxiconazole, tricyclazole and a further, commercially available fungicide is employed.

13. The method according to claim 8, wherein the active ingredients are applied simultaneously, that is jointly or separately, or in succession.

14. The method according to claim 8, wherein the combination is applied in an amount of from 20 g/ha to 1000 g/ha.

15. A method for protecting rice from being infected by phytopathogenic harmful fungi, comprising treating the fungi, their habitat, rice plants, their seed, rice plant propagation material or the soil on which rice is grown or intended to be grown with epoxiconazole and tricycloazole in a synergistically effective amount wherein the compounds are applied simultaneously, that is jointly or separately, or in succession.

16. The method according to claim 15, wherein an aqueous preparation of a formulation comprising epoxiconazole and tricyclazole is applied to the above-ground parts of the rice plants.

17. A method according to claim 15, whereas plant propagation material is treated.

18. The method according to claim 15, wherein a combination of epoxiconazole, tricyclazole and a further, commercially available fungicide is employed.

19. The method according to claim 15, wherein the active ingredients are applied simultaneously, that is jointly or separately, or in succession.

20. The method according to claim 15, wherein the combination is applied in an amount of from 20 g/ha to 1000 g/ha.
